(19) United States
(12) Patent Application Publication
(10) Pub. No.: US 2008/0287157 A1
(43) Pub. Date: Nov. 20, 2008

(54) WIRELESS MOBILE COMMUNICATIONS TERMINALS AND METHODS USING THE SAME

(75) Inventor: Sally White, Bjarred (SE)

Correspondence Address: MYERS BIGEL SIBLEY & SAJOVEC, P.A., P.O. BOX 37428, RALEIGH, NC, 27627, US

(73) Assignee: Sony Ericsson Mobile Communications AB

(21) Appl. No.: 11/748,935

(22) Filed: May 15, 2007

(51) Int. Cl. H04M 1/00

(52) U.S. Cl. 455/550.1; 455/566

(57) ABSTRACT

A mobile wireless communications terminal includes a housing having a front side and top and bottom opposed ends. A controller is mounted on the housing. A keypad is located on the front side of the housing. A keypad includes text input keys connected to the controller and selectively operable to input text character commands to the controller. A space key is located on the front side of the housing and is connected to the controller. The space key is selectively operable to input a text space command to the controller. The space key is located above the keypad between the keypad and the top end of the housing.

### FIELD OF THE INVENTION

The present invention relates to electronic devices and, more particularly, to wireless mobile communications terminals and methods using the same.

### BACKGROUND OF THE INVENTION

Many mobile wireless communications devices such as cellular telephones provide man-machine interfaces that include a keypad, such as a traditional telephone keypad, and various navigational keys and/or soft keys. The keypad includes multifunction keys that may be used to enter number characters, letter characters, or spaces between characters. Such keypads are increasingly being more heavily used to compose text messages and input various data. Ergonomics improvements in such man-machine interfaces are therefore highly desirable.

### SUMMARY OF THE INVENTION

According to embodiments of the present invention, a mobile wireless communications terminal includes a housing having a front side and top and bottom opposed ends. A controller is mounted on the housing. A keypad is located on the front side of the housing. The keypad includes text input keys connected to the controller and selectively operable to input text character commands to the controller. A space key is located on the front side of the housing and is connected to the controller. The space key is selectively operable to input a text space command to the controller. The space key is located above the keypad between the keypad and the top end of the housing.

According to some embodiments, the keypad is a numeric keypad. The numeric keypad may be a telephone keypad.

According to some embodiments, the mobile wireless communications terminal further includes a navigation input device on the front side of the housing between the keypad and the top end of the housing and connected to the controller, and the space key is located adjacent the navigation input device. In some embodiments, the navigation input device includes at least one of a rocker key and a joystick.

The mobile wireless communications terminal may further include a display on the front side of the housing with the space key being located between the keypad and the display. In some embodiments, the housing includes an upper housing portion and a lower housing portion connected to the upper housing portion such that the upper and lower housing portions are relatively movable between an open position and a closed position, the keypad is located in the lower housing portion, and the display is mounted in the upper housing portion. In some embodiments, the space key is located in the lower housing portion. According to some embodiments, the space key is located in the upper housing portion. The upper and lower housing portions can be relatively pivotable between the open and closed positions. The upper and lower housing portions can be relatively slidable along a slide axis between the open and closed positions.

According to some embodiments, the mobile wireless communications terminal is operable to compose text messages using the text input keys and the space key. The mobile wireless communications terminal may be operable to compose Short Message Service (SMS) text messages using the text input keys and the space key.

In some embodiments, the space key is a multi-function key selectively operable in a first key mode to input the text space command to the controller and selectively operable in a second key mode to input an alternative command to the controller, wherein the alternative command is not a text space command.

According to some embodiments, the mobile wireless communications terminal is a cellular telephone.

According to some embodiments, the cellular telephone is a handheld cellular telephone, the keypad is a numeric telephone keypad, and the handheld cellular telephone further includes: a navigation input device on the front side of the housing between the keypad and the top end of the housing and connected to the controller; a display on the front side of the housing between the navigation input device and the top end of the housing and connected to the controller, with the space key being located adjacent the navigation input device and between the keypad and the display. In some embodiments, the housing includes an upper housing portion and a lower housing portion connected to the upper housing portion such that the upper and lower housing portions are relatively movable between an open position and a closed position, the keypad is located in the lower housing portion, and the display is mounted in the upper housing portion.

The mobile wireless communications terminal may be a handheld wireless communications terminal.

According to further embodiments of the present invention, the space key is located at least about 3 cm from the bottom end of the housing.

According to further embodiments of the present invention, a method includes providing a mobile wireless communications terminal including: a housing having a front side and top and bottom opposed ends; a controller mounted on the housing; a keypad on the front side of the housing, the keypad including text input keys connected to the controller and being selectively operable to input text character commands to the controller; and a space key on the front side of the housing and connected to the controller, wherein the space key is selectively operable to input a text space command to the controller; wherein the space key is located above the keypad between the keypad and the top end of the housing. The method further includes actuating the space key to input the text space command to the controller.

Further features, advantages and details of the present invention will be appreciated by those of ordinary skill in the art from a reading of the figures and the detailed description of the preferred embodiments that follow, such description being merely illustrative of the present invention.

### BRIEF DESCRIPTION OF THE DRAWINGS

FIG. 1 is a schematic diagram of a mobile wireless communications terminal according to embodiments of the present invention and an exemplary wireless communications network.

FIG. 2 is a perspective view of the mobile wireless communications terminal of FIG. 1.

FIG. 3 is an enlarged, fragmentary, front plan view of the mobile terminal of FIG. 1.

FIG. 4 is a perspective view of a mobile wireless communications terminal according to further embodiments of the present invention.

### DETAILED DESCRIPTION OF EMBODIMENTS OF THE INVENTION

The present invention now will be described more fully with reference to the accompanying drawings, in which embodiments of the invention are shown. However, this invention should not be construed as limited to the embodiments set forth herein. Rather, these embodiments are provided so that this disclosure will be thorough and complete, and will fully convey the scope of the invention to those skilled in the art. Like numbers refer to like elements throughout.

As used herein, the term “comprising” or “comprises” is open-ended, and includes one or more stated features, integers, elements, steps, components or functions but does not preclude the presence or addition of one or more other features, integers, elements, steps, components, functions or groups thereof.

As used herein, the term “and/or” includes any and all combinations of one or more of the associated listed items.

As used herein, the common abbreviation “e.g.”, which derives from the Latin phrase “exempli gratia,” may be used to introduce or specify a general example or examples of a previously mentioned item, and is not intended to be limiting of such item. If used herein, the common abbreviation “i.e.”, which derives from the Latin phrase “id est,” may be used to specify a particular item from a more general recitation.

The terminology used herein is for the purpose of describing particular embodiments only and is not intended to be limiting of the invention. As used herein, the singular forms “a”, “an” and “the” are intended to include the plural forms as well, unless the context clearly indicates otherwise.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

In addition, spatially relative terms, such as “under”, “below”, “lower”, “over”, “upper” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “under” or “beneath” other elements or features would then be oriented “over” the other elements or features. Thus, the exemplary term “under” can encompass both an orientation of over and under. The device may be otherwise oriented (rotated 90 degrees or at other orientations) and the spatially relative descriptors used herein interpreted accordingly.

It will be understood that when an element is referred to as being “coupled” or “connected” to another element, it can be directly coupled or connected to the other element or intervening elements may also be present. In contrast, when an element is referred to as being “directly coupled” or “directly connected” to another element, there are no intervening elements present. Furthermore, “coupled” or “connected” as used herein may include wirelessly coupled or connected.

Well-known functions or constructions may not be described in detail for brevity and/or clarity.

As used herein, “electronic component” means an active device as contrasted with a passive electrical connector or the like. An electronic component may include a processor.

As used herein, a “communication terminal” includes, but is not limited to, a terminal that is configured to receive/transmit communication signals via a wireline connection, such as via a public-switched telephone network (PSTN), digital subscriber line (DSL), digital cable, or another data connection/network, and/or via a wireless interface with, for example, a cellular network, a satellite network, a wireless local area network (WLAN), and/or another communication terminal.

When the communication terminal is configured to communicate over a wireless interface, it is referred to herein as a “wireless communication terminal” or a “wireless terminal.” Examples of wireless terminals include, but are not limited to, a cellular telephone, personal data assistant (PDA), pager, and/or a computer that is configured to communicate data over a wireless communication interface that can include a cellular telephone interface, a Bluetooth interface, a wireless local area network interface (e.g., 802.11), another RF communication interface, and/or an optical/infra-red communication interface.

As used herein, “mobile terminals” may be portable, transportable, installed in a vehicle (aeronautical, maritime, or land-based), or situated and/or configured to operate locally and/or in a distributed fashion at any other location(s) on earth and/or in space.

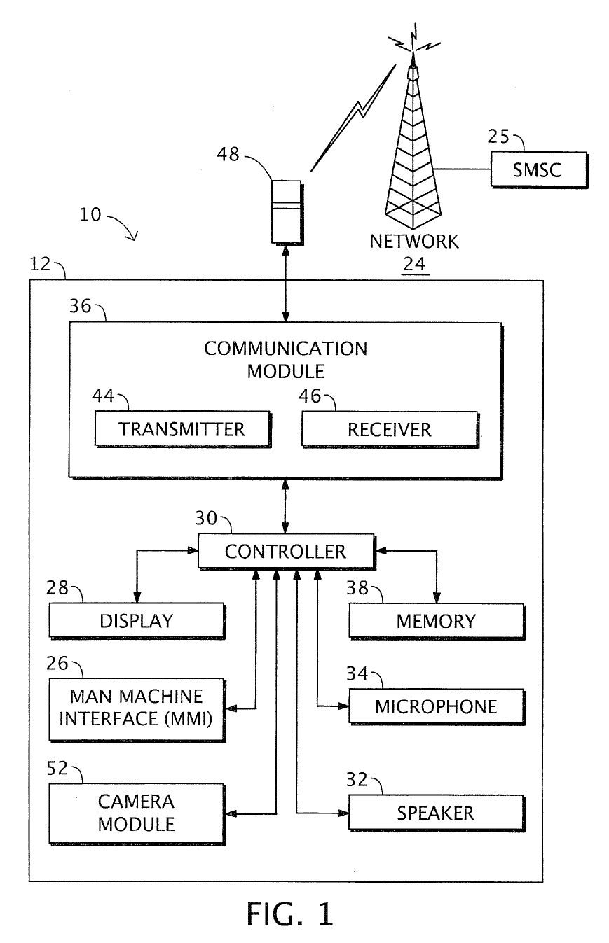

Embodiments of the present invention will now be described below with respect to FIGS. 1-3. Embodiments of the present invention provide a mobile wireless communications terminal 10 including a man-machine interface (MMI) or input device system that may used to input space commands. According to some embodiments, the man-machine interface can be used to compose text messages including spaces between characters. The mobile wireless communications terminal may provide improvements and advantages in performance and/or usability over conventional character entry or texting enabled-mobile wireless communications terminal.

Referring now to FIG. 1, an exemplary radiotelephone communication system in accordance with embodiments of the present invention is illustrated, which includes the mobile wireless communication terminal 10 and a base station transceiver, which is part of a wireless communications network 24. In some embodiments of the present invention, the network 24 includes a base station transceiver that includes the radio transceiver(s) that define an individual cell in a cellular network and communicates with the mobile terminal I/O and other mobile terminals in the cell using a radio-link protocol. It will be understood that, in some embodiments of the present invention, many base station transceivers may be connected through, for example, a mobile switching center and other devices to define a wireless communications network.

The network 24 may be further connected to one or more text message handling servers or services that enable exchange of text or character messages. According to some embodiments, such text message handling services include one or more Short Message Service Centers (SMSC) 25 that process text Short Message Service (SMS) messages. As is well known to those of skill in the art, SMS refers to a personal communications service that provides communication of text messages between mobile communication terminals, typically GSM, CDMA or PCS system subscribers. The network 24 and the SMSC 25 may enable a user to send and receive text messages using the mobile terminal 10. More particularly, the user may compose text messages on the mobile terminal 10 and forward those text messages via the network 24 and the SMSC 25. The construction, operation and usage of SMSs, SMSCs, and mobile terminals capable of sending and receiving SMS messages are well known to those of skill in the art and therefore will not be described in further detail herein. Additionally or alternatively, the mobile terminal 10 and the network 24 may be configured and enabled to exchange text messages of types other than SMS, as well.

The mobile terminal 10 includes a portable housing 12 and a man machine interface (MMI) 26, as described in more detail below. The mobile terminal 10 also includes a display device or unit 28, a speaker 32, a microphone 34, a transceiver or communication module 36, and a memory 38 including application information and parameters, any of which may communicate with a processor or controller 30. Furthermore, the mobile terminal 10 according to embodiments of the present invention may further include a digital camera module 52, which also communicates with the controller 30. Other user interface devices may be provided such as other suitable input device(s).

The speaker 32 generates sound responsive to an input audio signal. The microphone 34 is coupled to an audio processor that is configured to generate an audio data stream responsive to sound incident on the microphone. The display device 28 may include, for example, a liquid crystal display (LCD) module.

The communication module 36 can include a cellular communication module, a direct point-to-point connection module, and/or a WLAN module. With a cellular communication module, the wireless terminal 10A can communicate via the base station(s) of the network using one or more cellular communication protocols such as, for example, Advanced Mobile Phone Service (AMPS), ANSI-136, Global Standard for Mobile (GSM) communication, General Packet Radio Service (GPRS), enhanced data rates for GSM evolution (EDGE), code division multiple access (CDMA), wideband-CDMA, CDMA2000, and Universal Mobile Telecommunications System (UMTS). The cellular base stations may be connected to a Mobile Telephone Switching Office (MTSO) wireless network, which, in turn, can be connected to a PSTN and/or another network.

The communication module 36 may include a transceiver typically having a transmitter circuit 44 and a receiver circuit 46, which respectively transmit outgoing radio frequency signals (e.g., to the network 24, a router or directly to another terminal) and receive incoming radio frequency signals (e.g., from the network 24, a router or directly from another terminal), such as voice and data signals, via an antenna 48. The communication module 36 may include a short-range transmitter and receiver, such as a Bluetooth transmitter and receiver. The antenna 48 may be an embedded antenna, a retractable antenna or any antenna known to those having skill in the art without departing from the scope of the present invention. The radio frequency signals transmitted between the mobile terminal 10 and the network 24 may include both traffic and control signals (e.g., paging signals/messages for incoming calls), which are used to establish and maintain communication with another party or destination. The radio frequency signals may also include packet data information, such as, for example, cellular digital packet data (CDPD) information. In addition, the transceiver may include an infrared (IR) transceiver configured to transmit/receive infrared signals to/from other electronic devices via an IR port.

The controller 30 may support various functions of the mobile terminal 10. The controller 30 can be any commercially available or custom microprocessor, for example. In use, the controller 30 of the mobile terminal 10 generates a display image on the display device 28.

According to some embodiments, the controller 30 is operable to place the terminal 10 in a text messaging operational mode. When the terminal 10 is in the text messaging mode, the user can compose a text message (such as an SMS text message) on the terminal 10 and send the text message to another terminal (e.g., via the network 24 and the SMSC 25). According to some embodiments, the controller 30 is also operable to alternatively place the terminal 10 in an alternative operational mode. Such alternative operational modes may include, for example, a voice telephone communication operational mode, a music playback operational mode, a camera operational mode, etc. The controller 30 may toggle between the alternative operational mode(s) in any suitable manner. The mobile terminal 10 may include suitable computer program product applications or modules (e.g., software or firmware) to enable the desired functions of the various operational modes.

The foregoing components of the mobile terminal 10 may be included in many conventional mobile terminals and their functionality is generally known to those skilled in the art. As used herein, the term “portable electronic device” or “mobile terminal” may include: a cellular radiotelephone with or without a multi-line display; a Personal Communications System (PCS) terminal that may combine a cellular radiotelephone with data processing, facsimile and data communications capabilities; a Personal Data Assistant (PDA) that can include a radiotelephone, pager, Internet/intranet access, Web browser, organizer, calendar and/or a global positioning system (GPS) receiver; a gaming device, an audio video player, and a conventional laptop and/or palmtop portable computer that may include a radiotelephone transceiver.

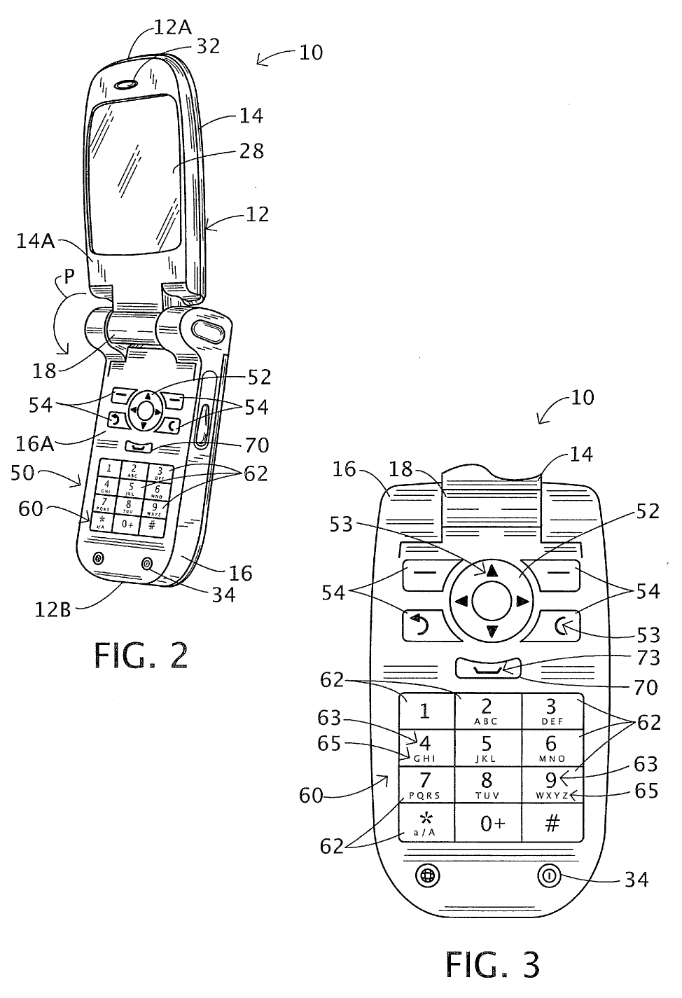

According to some embodiments and as illustrated in FIGS. 2 and 3, the mobile terminal 10 is a handheld (portable) mobile terminal. By “handheld mobile terminal,” it is meant that the outer dimensions of the mobile terminal are adapted and suitable for use by a typical operator using one hand. According to some embodiments, the total volume of the handheld mobile terminal is less than about 200 cc. According to some embodiments, the total volume of the handheld terminal is less than about 100 cc. According to some embodiments, the total volume of the handheld mobile terminal is between about 50 and 100 cc. According to some embodiments, no dimension of the handheld mobile terminal 10 exceeds about 200 mm.

The housing 12 may be formed of a polymeric material, such as polystyrene. Alternatively or additionally, the housing 12 may be formed of any other suitable material, such as metal. The housing 12 may be molded and may be assembled from multiple parts. The housing 12 has opposing top and bottom ends 12A and 12B and includes an upper or top subhousing or housing portion 14 and a lower or bottom subhousing or housing portion 16. As used herein, “top,” “bottom,” “upper” and “lower” refer to the relative general positions of the components or features when the mobile terminal 10 is in its open position and held in the typical, generally upright orientation for usage. The upper housing portion 14 is pivotally coupled to the lower housing portion 16 by a hinge mechanism 18 to form a clamshell housing assembly. The housing portions 14, 16 can be pivoted about a transverse axis of the hinge mechanism 18 between an open or deployed position as shown in FIGS. 2 and 3 and a stored or closed position wherein the housing portion 14 overlies (i.e., is folded in a direction P over and onto) the housing portion 16. Handheld wireless communication terminals having clamshell housings as shown are commonly referred to as “flip phones.” The housing portions 14, 16 have respective front walls 14A, 16A defining their front sides. One or both of the housing portions 14, 16 define an interior cavity (not shown) that contains various components of the mobile terminal 10, including the controller 30. The display 28 is mounted in the front wall 14A of the upper housing portion 14.

Referring to FIGS. 2 and 3, the MMI 26 includes a set of mechanical input devices 50 mounted on the front side 16A of the lower housing portion 16. As illustrated, the set of input devices 50 includes a rocker key 52, auxiliary keys 54, a keypad 60 (which includes a set of twelve keys 62), and a space key 70. Each of the input devices 52, 54, 62, 70 is connected to the controller 30 (for example, by an associated electromechanical switch) so that when the key is actuated the controller 30 registers a corresponding command. The input devices 52, 54, 62, 70 are selectively actuatable by the user pressing, deflecting and/or touching the respective key. According to some embodiments, at least the keys 62 and 70 are buttons that are actuated by pressing and displacing the button.

Some or all of the keys 62 of the keypad 60 are multifunction input keys. The keys 62 are primarily labeled with indicia 63 of numerals “0” to “9”, and symbols “*” and “#”. The keys 62 of the keypad 60 are secondarily labeled with indicia 65 of letters “A” to “Z”, symbol “+”, and case shift “a/A”. Some of the keys 62 bear secondary labels for multiple letters.

According to some embodiments, the keypad 60 is a numeric keypad. According to some embodiments, the keys 62 are arranged in sequential order according to their assigned primary characters. According to some embodiments and as illustrated, the keypad 60 is a numeric keypad having a traditional telephone keypad layout or configuration (referring to the primary designations 63 of the keys 62). The keypad 60 may have a nine-digit or, as shown, twelve-digit telephone keypad layout. According to some embodiments, the keypad 60 complies with at least one of the following standards applicable to multi-function keypads for radiotelephone: International standard ITU E.161 (also known as ANSI T1.703-1995/1999) and/or ISO/IEC 9995-8:1994. According to further embodiments, other types or configurations of keypads may be provided, such as an alphanumeric (e.g., QWERTY) keypad.

Each key 62 is enabled to input the characters or commands indicated thereon to the controller 30 when properly actuated by the user. Each key 62 bearing multiple indicia may be used to alternatively input each of the indicated characters or commands depending on the operational mode, selected input field, and operation by the user. For example, in accordance with some embodiments and as implemented in some conventional mobile cellular telephones, when a key 62 is actuated while a cursor is located in some fields (e.g., a phone number entry field), the key 62 is only enabled to enter the primary character 63 associated with that key 62. When the cursor is located in other fields (e.g., a phone directory “name” entry field or a text message composition field), the user can enter a desired character (primary 63 or secondary 65) by pressing the associated key 62 (which causes the controller 30 to display each of the characters associated with the key 62) until the desired character appears in the field (a technique or system commonly referred to be “multi-tapping”). The user can then wait a prescribed period of time or press another key 62 to accept or enter the displayed character. Other methods of enabling input using multifunction keys and/or single function keys may also be used in accordance with further embodiments of the present invention.

The rocker key 52 and/or the auxiliary keys 54 may serve as navigational input keys for moving about and selecting between screens, menus, modes, and the like. The rocker key 52 and the auxiliary keys 54 may be labeled with suitable indicia 53 corresponding to their input command functions. Other types of mechanical input devices may be provided. For example, a joystick input device, click wheel or the like may be provided in place of the rocker key 52. The rocker key 52 and/or the auxiliary keys 54 may be soft keys, the function of which will be labeled or indicated on the display 28 in accordance with the current operational mode, selected menu or the like.

The space key is labeled with indicia 73 denoting a space, such as “space” or the common symbol “\______/,” which is commonly used for this purpose. The space key 70 is selectively actuatable by the user to input a space command to the controller 30. For example, when the terminal 10 is in a text composing mode, the space key 70 can be actuated to command the controller 30 to insert a space in the text field where indicated (e.g., at or adjacent a cursor).

The display 28 is located above the keypad 60 as is common for handheld wireless communications terminals. The rocker key 52 and the auxiliary keys 54 are located above the keypad 60 and below the display 28 as is common for handheld wireless communications terminals. According to some embodiments and as shown, the keypad 60 is located in the lower housing portion 16.

The space key 70 is located above the keypad 60. According to some embodiments and as shown, the space key 70 is located between the keypad 60 and the keys 52, 54. According to some embodiments and as shown, the space key 70 is located adjacent the rocker key 52. According to some embodiments and as shown, the space key 70 is located between the keypad 60 and the display 28. The space key 70 may be substantially centered between the side edges of the housing portion 16.

According to some embodiments, the distance from the space key 70 to the bottom end 12B of the housing 12 is at least about 3 cm and, according to some embodiments, this distance is between about 3 and 5.5 cm. According to some embodiments, the distance from the space key 70 to the bottommost, rightmost corner of the housing 12 is at least about 3 cm and, according to some embodiments, this distance is between about 3 and 5.5 cm.

The set of input devices 50 may be used in the same manner as known cellular telephone MMIs except for the provision of space insert commands. In conventional cellular telephones, the space command is typically provided as a secondary function of the “#” key of the numeric keypad, which is traditionally positioned in the lowermost rightmost position of the numeric keypad array. This key may be labeled “#/space” or the like to indicate its dual function. Typically, in certain modes and/or entry fields such as phone number entry fields, actuating the “#/space” key enters the “#” character. In other modes and/or entry fields such as a name or text message entry field, actuating the “#/space” keys enters a space. Because the traditional “#/space” key is located in the bottom, right corner of the cellular telephone, many users struggle to press the key to enter a space while trying to maintain a secure and comfortable grip on the phone. This may present a problem in particular for users who hold the phone with their right hand (as is typical for right-handed users) while attempting to press the “#/space” key with their right thumb and thus must overcome a difficult or uncomfortable angle of reach. These problems are exacerbated for users who compose many text messages, which often require frequent entry of the space command.

By contrast, with the mobile terminal 10, the user can enter space insert commands by actuating (e.g., pressing) the space key 70. The placement of the space key 70 on the housing 12 relative to the keypad 60 can provide substantial ergonomic and performance improvements as compared to the traditional cellular telephone MMI as described above. A user's thumb naturally and comfortably rests on or adjacent the region of the rocker key 52. The convenient location of the space key 70 enables the user to press the space key 70 with the user's thumb without having to draw the thumb into a twisted or cramped position. Moreover, when pressing the space key 70 with the thumb of the hand holding the lower housing portion 16, the mobile terminal 10 is stable and securely held. Right-handed users may experience a particular improvement. The more ergonomic positioning of the space command key may make composing text messages such as SMS messages simpler, faster, less tiring and/or less likely to induce repetitive motion injury.

The space key 70 may also be a multi-function key that is enabled under appropriate conditions to enter an alternative command to the controller 30 other than the enter space command (for example, in an operation mode or field where spaces are not needed). The space key 70 may be provided with further indicia to indicate the alternative command.

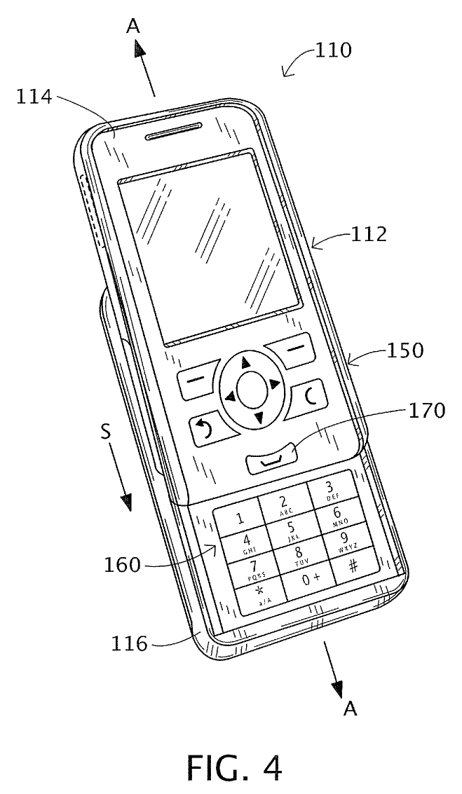

With reference to FIG. 4, a mobile wireless communications terminal 10 according to further embodiments of the present invention is shown therein. The mobile terminal 110 corresponds to the mobile terminal 10 except that the mobile terminal 110 is of a configuration commonly referred to as a “slider phone.” The housing 112 includes an upper housing portion 114 that is slidably mounted on a lower housing portion 116 such that the upper housing portion 114 can be slid on the housing portion 116 along a slide axis A-A between an open or deployed position as shown in FIG. 4 and a closed or stored position wherein the upper housing portion 114 overlies (i.e., is slid in a direction S onto and over) the lower housing portion 116. The mobile terminal 110 includes a set of input devices 150 corresponding to the set of input devices 50. In particular, the mobile terminal 110 includes a numeric keypad 160 corresponding to the numeric keypad 60 and a space key 170 corresponding to the space key 70 and likewise positioned above the keypad 160. In the illustrated embodiment, the space key 170 is located on the upper housing 114. According to further embodiments, the space key 170 may be located on the lower housing 116. According to some embodiments, the space key 170 is spaced apart from the bottom end and/or the bottommost, rightmost corner of the lower housing portion 114 by the same distances as described above with regard to the terminal 10 when the terminal 110 is in its open position (FIG. 4).

According to further embodiments, a mobile wireless communications terminal may be formed and configured as described above but with a housing that is of a “one-piece” construction (i.e., does not have relatively movable housing portions).

Many alterations and modifications may be made by those having ordinary skill in the art, given the benefit of present disclosure, without departing from the spirit and scope of the invention. Therefore, it must be understood that the illustrated embodiments have been set forth only for the purposes of example, and that it should not be taken as limiting the invention as defined by the following claims. The following claims, therefore, are to be read to include not only the combination of elements which are literally set forth but all equivalent elements for performing substantially the same function in substantially the same way to obtain substantially the same result. The claims are thus to be understood to include what is specifically illustrated and described above, what is conceptually equivalent, and also what incorporates the essential idea of the invention.

What is claimed is:

1. A mobile wireless communications terminal comprising:
a housing having a front side and top and bottom opposed ends;
a controller mounted on the housing;
a keypad on the front side of the housing, the keypad including text input keys connected to the controller and being selectively operable to input text character commands to the controller; and
a space key on the front side of the housing and connected to the controller, wherein the space key is selectively operable to input a text space command to the controller;
wherein the space key is located above the keypad between the keypad and the top end of the housing.

2. The mobile wireless communications device of claim 1 wherein the keypad is a numeric keypad.

3. The mobile wireless communications terminal of claim 2 wherein the numeric keypad is a telephone keypad.

4. The mobile wireless communications terminal of claim 1 further including a navigation input device on the front side of the housing between the keypad and the top end of the housing and connected to the controller, wherein the space key is located adjacent the navigation input device.

5. The mobile wireless communications terminal of claim 4 wherein the navigation input device includes at least one of a rocker key and a joystick.

6. The mobile wireless communications terminal of claim 1 further including a display on the front side of the housing, wherein the space key is located between the keypad and the display.

7. The mobile wireless communications terminal of claim 6 wherein:
the housing includes an upper housing portion and a lower housing portion connected to the upper housing portion such that the upper and lower housing portions are relatively movable between an open position and a closed position;
the keypad is located in the lower housing portion; and
the display is mounted in the upper housing portion.

8. The mobile wireless communications terminal of claim 7 wherein the space key is located in the lower housing portion.

9. The mobile wireless communications terminal of claim 7 wherein the space key is located in the upper housing portion.

10. The mobile wireless communications terminal of claim 7 wherein the upper and lower housing portions are relatively pivotable between the open and closed positions.

11. The mobile wireless communications terminal of claim 7 wherein the upper and lower housing portions are relatively slidable along a slide axis between the open and closed positions.

12. The mobile wireless communications terminal of claim 1 wherein the mobile wireless communications terminal is operable to compose text messages using the text input keys and the space key.

13. The mobile wireless communications terminal of claim 12 wherein the mobile wireless communications terminal is operable to compose Short Message Service (SMS) text messages using the text input keys and the space key.

14. The mobile wireless communications terminal of claim 1 wherein the space key is a multi-function key selectively operable in a first key mode to input the text space command to the controller and selectively operable in a second key mode to input an alternative command to the controller, wherein the alternative command is not a text space command.

15. The mobile wireless communications terminal of claim 1 wherein the mobile wireless communications terminal is a cellular telephone.

16. The mobile wireless communications terminal of claim 15 wherein:
the cellular telephone is a handheld cellular telephone;
the keypad is a numeric telephone keypad;
the handheld cellular telephone further includes:
a navigation input device on the front side of the housing between the keypad and the top end of the housing and connected to the controller; and
a display on the front side of the housing between the navigation input device and the top end of the housing and connected to the controller; and
the space key is located adjacent the navigation input device and between the keypad and the display.

17. The mobile wireless communications terminal of claim 16 wherein:
the housing includes an upper housing portion and a lower housing portion connected to the upper housing portion such that the upper and lower housing portions are relatively movable between an open position and a closed position;
the keypad is located in the lower housing portion; and
the display is mounted in the upper housing portion.

18. The mobile wireless communications terminal of claim 1 wherein the mobile wireless communications terminal is a handheld wireless communications terminal.

19. The mobile wireless communications terminal of claim 1 wherein the space key is located at least about 3 cm from the bottom end of the housing.

20. A method comprising:
providing a mobile wireless communications terminal including:
a housing having a front side and top and bottom opposed ends;
a controller mounted on the housing;
a keypad on the front side of the housing, the keypad including text input keys connected to the controller and being selectively operable to input text character commands to the controller; and
a space key on the front side of the housing and connected to the controller, wherein the space key is selectively operable to input a text space command to the controller;
wherein the space key is located above the keypad between the keypad and the top end of the housing and;
actuating the space key to input the text space command to the controller.
